(19) United States
(12) Patent Application Publication
(10) Pub. No.: US 2010/0287104 A1
(43) Pub. Date: Nov. 11, 2010

(54) Systems and Methods for Collaborative Innovation Management

(76) Inventor: Luc Leroy, Los Gatos, CA (US)

Correspondence Address: GEORGE MACK RIDDLE, 30 GREENFIELD DRIVE, MORAGA, CA, 94556, US

(21) Appl. No.: 12/772,145

(22) Filed: Apr. 30, 2010

Related U.S. Application Data
(60) Provisional application No. 61/176,070, filed on May 6, 2009.

(51) Int. Cl. G06Q 10/00

(52) U.S. Cl. 705/300; 709/204

(57) ABSTRACT

Systems and methods for collaborative innovation management. A computer-implemented system for management of collaboration among users comprises: a computer having at least a processor and memory; an input module for receiving a file submitted by a user to a designated project hosted by the system and input from the user and contributors associated with the designated project regarding the submitted file, wherein the input includes input regarding value of the submitted file; a storage module for storing the submitted file and data relating to the submitted file; and a server module for depositing the submitted file with an external deposit authority, soliciting input from the user and contributors associated with the designated project about the submitted file, calculating a value for the submitted file based on input from the user and the contributors and maintaining the calculated value with other values calculated for contributors to the designated project.

### CROSS REFERENCE TO RELATED APPLICATIONS

The present application is related to and claims the benefit of priority of the following commonly-owned, presently-pending provisional application(s): application Ser. No. 61176070, filed May 6, 2009, entitled “Systems and Methods for Collaborative Innovation Management”, of which the present application is a non-provisional application thereof. The disclosure of the foregoing application is hereby incorporated by reference in its entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 26811 Bytes, created: Apr. 27, 2010 9:08:58 AM; Object ID: File No. 1; Object Contents: Source code.

### BACKGROUND OF INVENTION

1. Field of the Invention

The present invention relates generally to systems and methodologies for managing and facilitating collaboration amongst individuals and organizations.

2. Description of the Background Art

Over time, the development of new products and technologies has increasingly become a collaborative activity involving multiple individuals and organizations. While certainly there are talented individual inventors and innovators, many new products and technologies are now emerging from networks of smaller companies and independent inventors rather than from large government or corporate labs. In recent years, the process of innovation has become ever more heterogeneous and fragmented and many companies today rely on third party suppliers and contributors for key elements of their product portfolios. This heterogeneous and interconnected technology environment requires that individuals and organizations must collaborate with others in developing, maintaining and improving their products so as to remain competitive.

The Internet has facilitated this trend towards increased collaboration and interdependence as it enables innovators to collaborate across distances and at different times. It has already changed the patterns of innovation in a wide variety of fields. For instance, the trend towards open source software production is an example of how the Internet facilitates widespread collaboration for developing new products and improving existing technologies. However, while it is well documented that collaboration among innovators can deliver various benefits, a number of barriers and challenges to collaborative innovation remain.

One problem is providing appropriate mechanisms to facilitate sharing information and encourage collaboration among individuals and organizations. Although there are existing mechanisms such as the Internet to make information available to others, such mechanisms are largely unstructured and do not provide a systematic way to facilitate collaboration. Additionally while existing source code management solutions keep records about source code contributions made to a given project, they do not provide a consistent and comprehensive approach as to how collaborators can make suggestions, comments, input or additional contributions nor do they provide a mechanism for commenting on the quality of contributions and/or attributing value to any particular contributions that are made.

One particular problem in an open collaborative development is determining who is the actual inventor or creator of particular work product such as a picture or other image, copyrightable work, invention, software source code, technical specification or the like. In an environment in which multiple individuals or organizations are creating new innovations, or are suggesting or making improvements to existing works, it can sometimes be difficult to determine what particular person or organization is responsible for particular innovations. This can create issues amongst the collaborators (as well as outsiders that are not collaborating) regarding such matters as attribution, inventorship, ownership and the like. Thus, it would be desirable to have a solution that clearly documented the particular individual or organization making a given contribution. Additionally, it is also desirable to document the date the particular contribution was made, as this information may be important for establishing that the contribution is novel, original work of the contributor (e.g., establishing date of conception or reduction to practice).

One existing approach that has been used to address some of these issues is for the inventor or creator of a work to make a deposit with a deposit authority. A person or entity creating work can deposit a copy with a deposit authority (e.g., a Hussier de Justice in France) that retains the copy as a record as to the state of the deposited work at a given point in time. One alternative for making a deposit with a deposit authority is to make a physical deposit of the material. For instance, a depositor can send a CD (or DVD or tape) to a deposit authority (e.g., through a special end drop). The deposit authority typically checks the content, makes a checksum and then places the CD (or DVD or tape) into a sealed bag and keeps a copy. The deposit agency also typically sends the depositor back a copy of the CD which is sealed. Another approach is to provide for the work to be deposited electronically. To make a deposit electronically, a depositor typically downloads and run a tool on their local machine (e.g., to calculate a checksum or other digital signature) and then uploads the deposit and some additional data to the deposit authority website. The information is processed and the depositor is given a key (identifier) for each submission that is deposited.

One example of an organization that accepts deposits of works is Interdeposit, a federation established in Geneva, Switzerland in 1994 to bring together the organizations involved in the deposit of digital works. Interdeposit has devised an international identification system that affords access to information concerning the ownership of rights and conditions of exploitation. Generally, a user wishing to make a deposit of a work electronically with Interdeposit makes a backup of the work and creates an electronic signature for the file containing the work. The user may also write any particular conditions the user wants to apply to the use and exploitation of his work and completes an on-line Interdeposit referencing form. When a deposit is made via the Interdeposit website, Interdeposit attributes an IDDN (Inter Deposit Digital Number) to the work. The user may then specify particular conditions for use and exploitation of the work.

Until recently, an inventor in the United States could also file a disclosure document with the U.S. Patent and Trademark Office (USPTO). In such case, the USPTO would hold the document in confidence so that it could, for example, be used as evidence of the conception date of a given invention. However, this disclosure document program has now been discontinued by the USPTO.

Depositing items with a deposit authority in one of the ways described above can be a useful way of documenting the state of development of a particular work at a given point in time. However, it is currently a fairly time consuming and somewhat costly undertaking to make a deposit in this fashion. Among other reasons, a separate fee is typically incurred every time one makes a deposit. More significantly, these existing solutions for making a deposit do not provide any mechanism encouraging others to comment on, adapt, use or improve upon the deposited materials. Therefore, existing approaches to deposits are not well suited to today's collaborative environment that may involve regular interactions among large, geographically dispersed groups of collaborators.

What is needed is a solution that facilitates collaboration amongst innovators by enabling them to make deposits of developed works and allowing other collaborators to make suggestions, comments, input or additional contributions so as to extend and improve upon the deposited work. The solution should also maintain accurate and complete records regarding the respective contributions of individuals and organizations participating in collaborative activities. The present invention provides a solution for these and other needs.

### SUMMARY OF INVENTION

Systems and methods for collaborative innovation management are described. In one embodiment, for example, a computer-implemented system for management of collaboration among a plurality of users comprises: a computer having at least a processor and memory; an input module for receiving a file submitted by a user to a designated project hosted by the system and input from the user and contributors associated with the designated project regarding the submitted file, wherein the input includes input regarding value of the submitted file; a storage module for storing the submitted file and data relating to the submitted file; and a server module for depositing the submitted file with an external deposit authority, soliciting input from the user and contributors associated with the designated project about the submitted file, calculating a value for the submitted file based on input from the user and the contributors and maintaining the calculated value with other values calculated for contributors to the designated project.

### BRIEF DESCRIPTION OF DRAWINGS

FIG. 1 is a very general block diagram of a computer system (e.g., an IBM-compatible system) in which software-implemented processes of the present invention may be embodied.

FIG. 2A is a screenshot illustrating a start screen of a web page of a web server of the current preferred embodiment.

FIG. 2B is a screenshot illustrating a login page for user login.

FIG. 2C is a screenshot illustrating a welcome page of the currently preferred embodiment.

FIG. 2D is a screenshot illustrating a submission screen provided in the currently preferred embodiment of the present invention.

FIG. 2E is a screenshot of an equity vote screen provided in the presently preferred embodiment.

FIG. 2F is a screenshot of a confirmation screen for providing confirmation of file upload and pending equity claim to the user.

FIG. 2G is a screenshot of an equity summary screen showing the allocated equity for an example project.

FIG. 3 is a block diagram illustrating an environment in which the present invention may be implemented.

FIG. 4 comprises a high-level contribution flowchart diagram illustrating contribution features of the present invention.

FIGS. 5A-B comprise a single high-level vote flowchart diagram illustrating the voting process of the present invention.

FIG. 6 comprises a high-level vote loop workflow diagram illustrating the voting loop process in further detail.

FIG. 7 is a high-level deposit workflow diagram illustrating the process of making a deposit with a deposit authority.

FIG. 8 is a high-level preview image handler workflow diagram depicting the methodology of the present invention for generating a preview image of an uploaded file.

### DETAILED DESCRIPTION

### Glossary

The following definitions are offered for purposes of illustration, not limitation, in order to assist with understanding the discussion that follows.

Equity: The term “equity” as used in this document in refers in general terms to recognition of the relative contribution made by a particular user or organization to a collective work. “Equity” does not necessarily represent ownership interest in any shares of stock or other financial instrument, although in some cases users of the solution may agree to allocate certain stock, monetary compensation, ownership interests or other consideration based on relative contribution of users to a collaboratively developed work. Instead, the term “equity” as used herein should be construed broadly to indicate recognition of the relative contribution (e.g., as a percentage of the total or as a number of “points” out of the total number of points allocated) a given individual or organization has made to a collective work.

MD5: MD5 is a message-digest algorithm which takes as input a message or file of arbitrary length and produces as output a 128-bit “fingerprint” or “message digest” of the input. The MD5 algorithm is used primarily in digital signature applications, where a large file must be “compressed” in a secure manner before being encrypted with a private (secret) key under a public-key cryptosystem. Further description of MD5 is available in “RFC 1321: The MD5 Message-Digest Algorithm”, (April 1992) available from the Internet Engineering Task Force, the disclosure of which is hereby incorporated by reference.

SHA: SHA stands for Secure Hash Algorithm, which are a set of cryptographic hash functions designed by the National Security Agency (NSA) and published by the NIST as a U.S. Federal Information Processing Standard. Currently, the three SHA algorithms are structured differently and are distinguished as SHA-0, SHA-1, and SHA-2. The SHA-2 family uses an identical algorithm with a variable digest size which is distinguished as SHA-224, SHA-256, SHA-384, and SHA-512. For further description of the Secure Hash Algorithm, see e.g., Federal Information Processing Standards Publication 180-2, Aug. 1, 2002 available from the National Institute of Standards and Technology, the disclosure of which is hereby incorporated by reference.

SQL: SQL stands for Structured Query Language. The original version called SEQUEL (structured English query language) was designed by IBM in the 1970′s. SQL-92 (or SQL/92) is the formal standard for SQL as set out in a document published by the American National Standards Institute in 1992; see e.g., “Information Technology—Database languages - SQL”, published by the American National Standards Institute as American National Standard ANSI/ISO/IEC 9075: 1992, the disclosure of which is hereby incorporated by reference. SQL-92 was superseded by SQL-99 (or SQL3) in 1999; see e.g., “Information Technology—Database Languages—SQL, Parts 1-5” published by the American National Standards Institute as American National Standard INCITS/ISO/IEC 9075-(1-5)-1999 (formerly ANSI/ISO/IEC 9075-(1-5) 1999), the disclosure of which is hereby incorporated by reference.

### INTRODUCTION

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows® or Linux operating systems. The present invention, however, is not limited to any one particular application or any particular environment. Instead, those skilled in the art will find that the system and methods of the present invention may be advantageously embodied on a variety of different platforms, including Macintosh, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

### Computer-based Implementation

Basic System Hardware and Software (e.g., for Desktop and Server Computers)

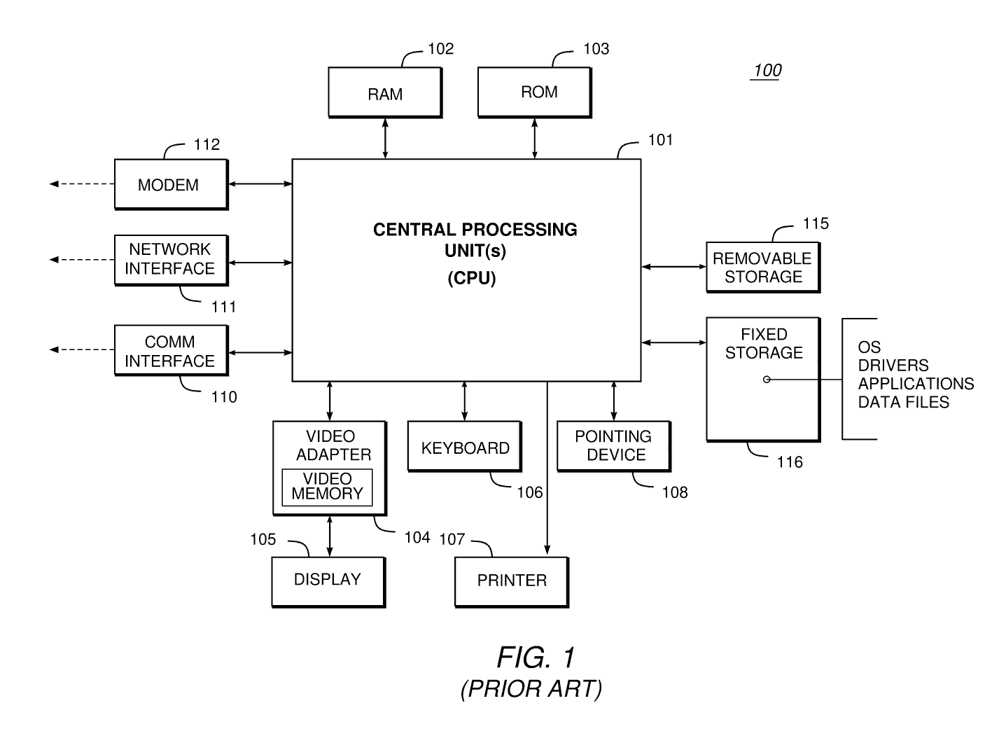

The present invention may be implemented on a conventional or general-purpose computer system, such as an IBM-compatible personal computer (PC) or server computer. FIG. 1 is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105 Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, a HP LaserJet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying desktop and server computer components that may be employed for implementing the present invention. The present invention, however, is not limited to any particular environment or device configuration. Instead, the present invention may be implemented in any type of system architecture or processing environment capable of supporting the methodologies of the present invention presented in detail below.

### Overview of Collaborative Innovation Management System and Methodology

Collaborative Projects

The present invention provides a solution that enables a network or community of individuals to work together collaboratively on projects of interest. The solution is flexible and may be used in conjunction with a variety of different types of works that may include, without limitation, drawings, images, photographs, bitmaps, technical specifications, ideas, inventions, documents, source code, CAD files, and a variety of other types of material.

An individual or organization may, for example, want to start up a new project or open up an existing (internal) project so that other contributors can assist in development efforts in a collaborative fashion. Initially, the present invention enables a user to upload work product, information and other materials relating to the project and provide for deposit of the work with a deposit authority, so as to maintain a record of the work developed by the user. The user may then elect to publish information about his or her project and invite contributions/assistance from other collaborators in developing/improving the project. For example, an organization having an existing open source software project could utilize the present invention to receive and manage contributions from an interested community of developers/users. The organization starting the project may utilize the present invention to make an initial deposit (e.g., of a given open source product release). The solution provides a mechanism enabling users to easily deposit created works and maintains information about these deposits.

The initial depositor may then elect to disclose the work to others (e.g., to specific invitees or the public at large) and encourage other contributors to provide feedback (e.g., comments, suggestions or the like) and/or propose additions, changes and improvements. Contributors can then utilize the system of the present invention submit feedback or proposed improvements (e.g., new modules, new releases or changes to existing modules). The solution also tracks submissions that are made and records and maintains detailed information about all such submissions. Submitted contributions are periodically deposited with a deposit authority so as to maintain a record of what was submitted, who made the contribution and when they made it. Additionally, the present invention provides mechanisms for review of submissions by other collaborators to determine whether or not to use submitted contributions and express opinions regarding them. Features of the present invention also provide for the award of “equity” in projects to those making contributions to recognize the relative contribution made by particular users or organizations to a collaboratively developed work. Each of these aspects is discussed below and illustrated with some examples.

User Registration and Access to Projects

For purposes of the following discussion, assume that a project is being organized for collaboratively developing components of a new “green” (environmentally friendly) motor vehicle utilizing the system and methodology of the present invention. Initially, an individual wishing to use the present invention for this type of project needs to register as a user before he or she can start using the system. In the presently preferred embodiment, before a user can have access to the content of a given project, he or she must register. For private or restricted projects, unregistered users can only see the project name and possibly a brief description of the project. However, a project can be made public, in which case any user can view details about the project.

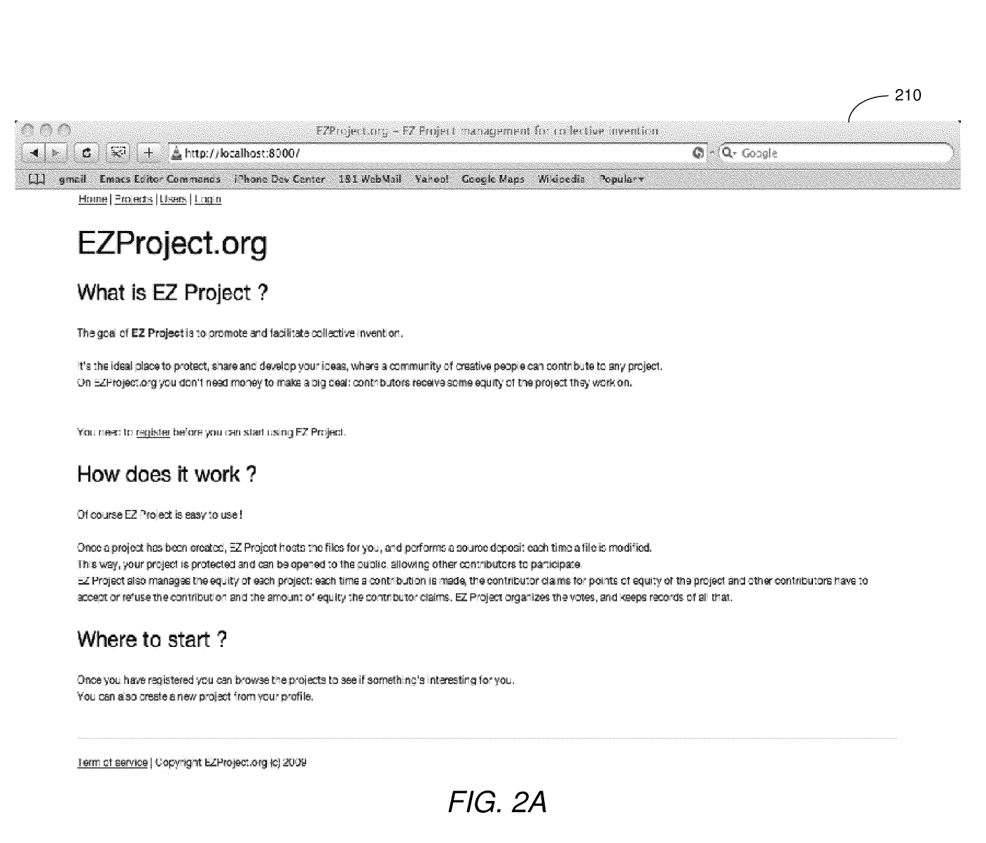

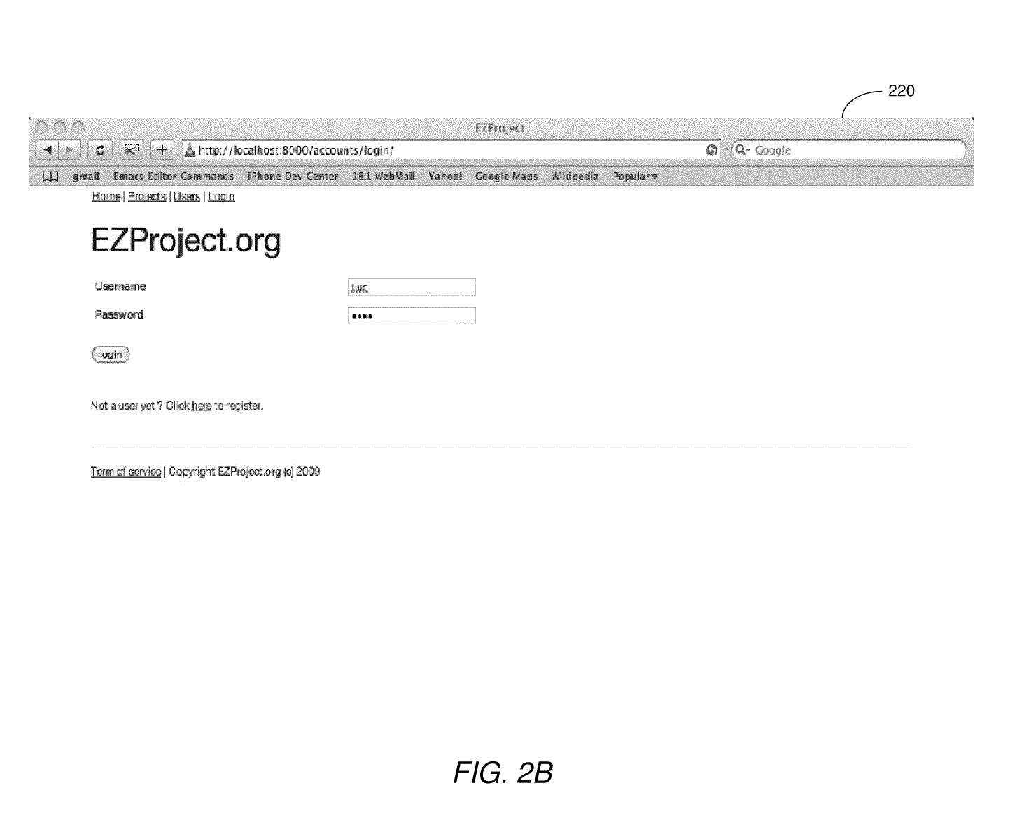

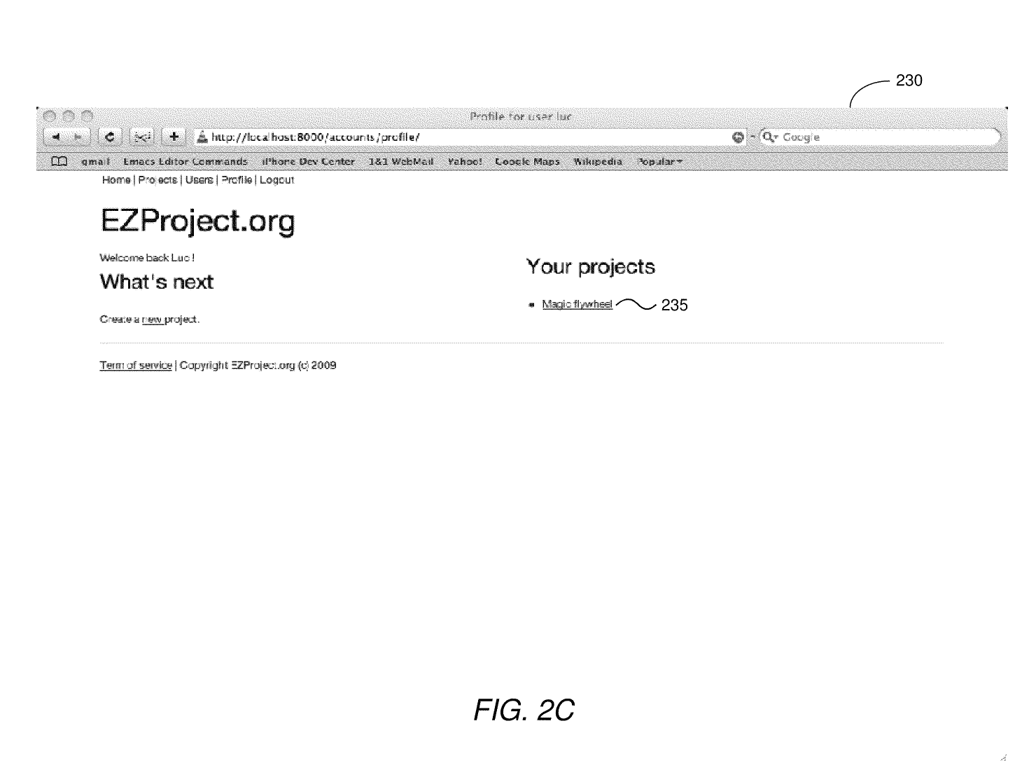

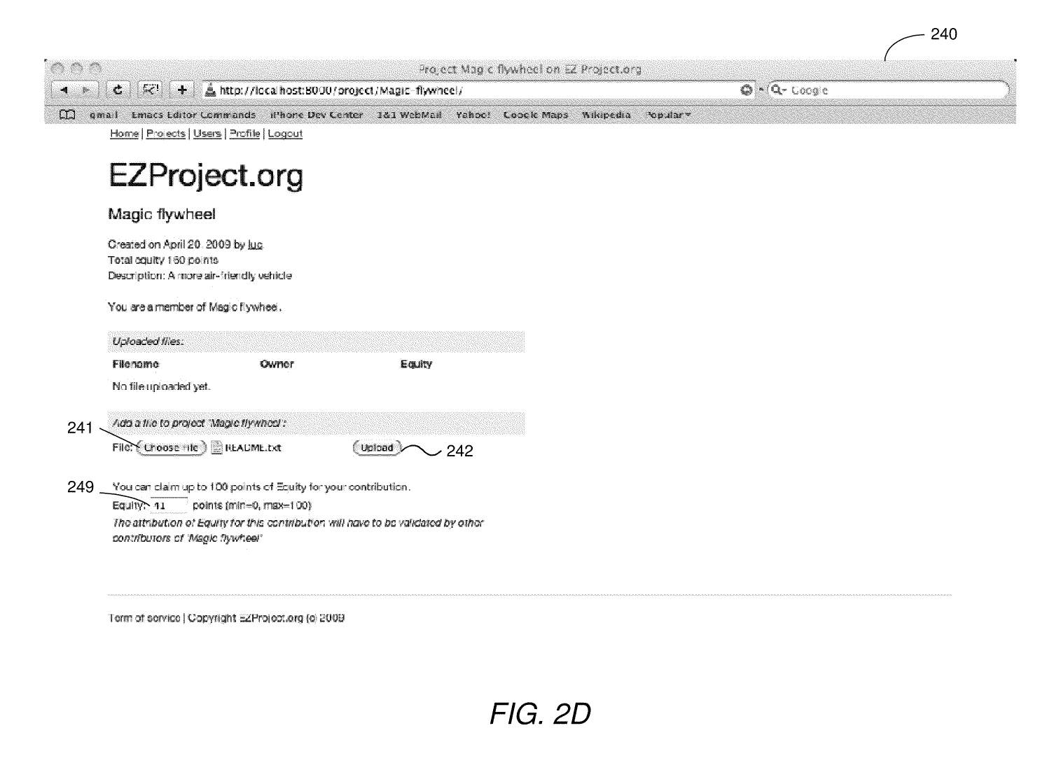

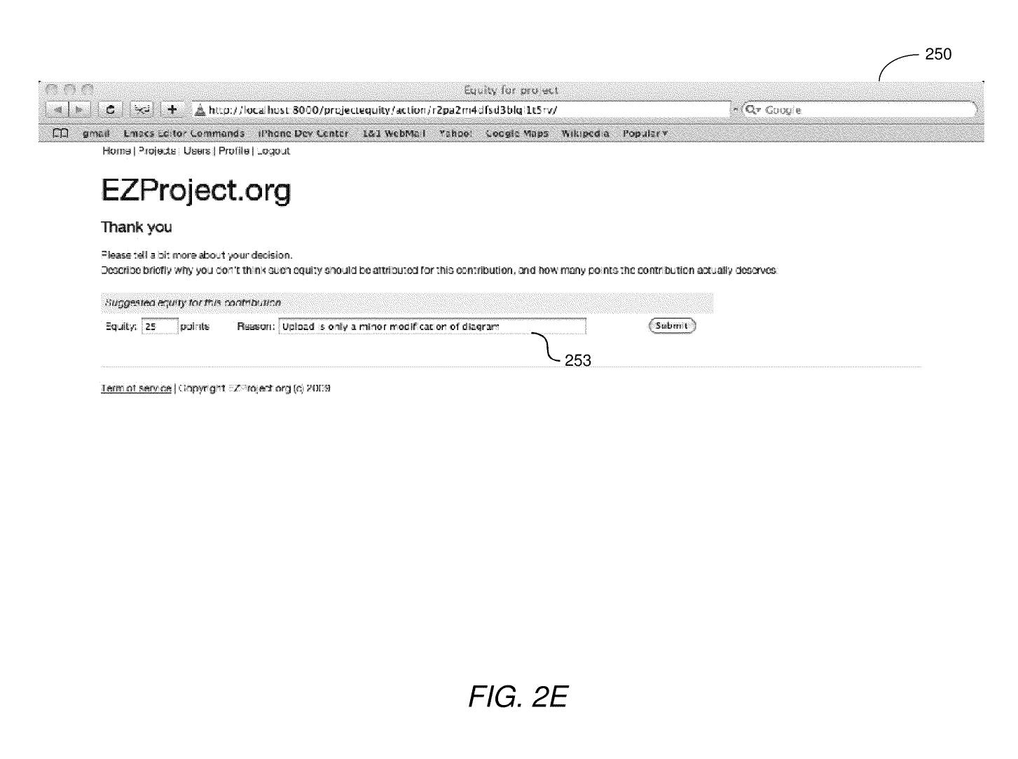

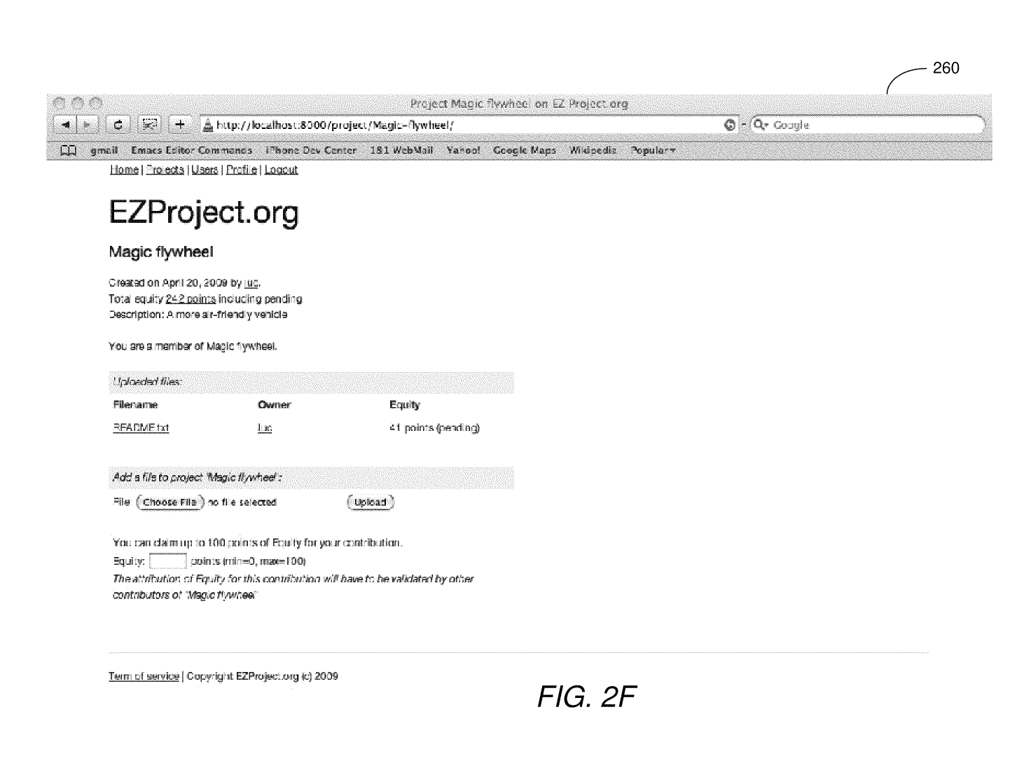

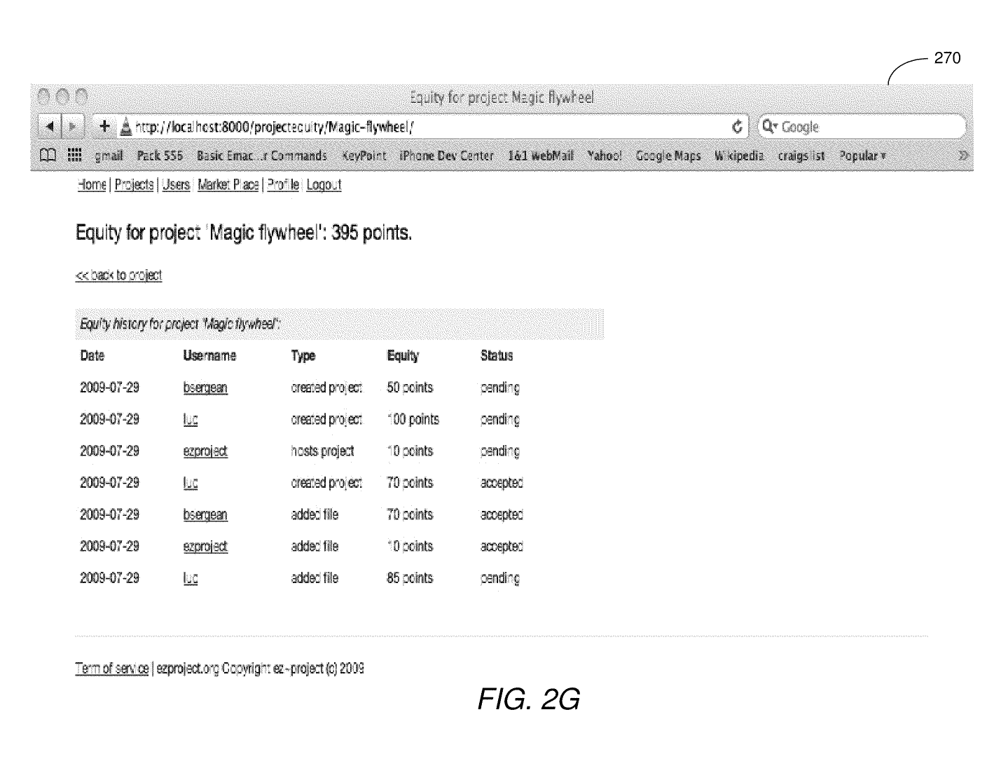

FIG. 2A is a screenshot illustrating a start screen 210 of a web page of a web server of the currently preferred embodiment. In order to register, a user would typically need to supply his or her last name, first name, country, zip code, username, and password. Once registered, the user can browse the server to find projects of interest (e.g., using project names and/or description), subject to privacy constraints applicable to particular projects. In the currently preferred embodiment a project can be private, restricted or public as follows:
Private project: only contributors of the project can see more than its name.
Restricted project: public access is permitted to the name and the description of the project, but content can be seen by contributors only.
Public project: everything is accessible by anyone; however, only contributors can make contributions or changes.

FIG. 2B is a screenshot illustrating a login page 220. In this case illustrated at FIG. 2B, the user has already registered, so upon entry of the username and password, the user is provided with access to the system. FIG. 2C is a screenshot illustrating the welcome page 230 of the currently preferred embodiment which is displayed after initial logon to the system. As shown at 235 at FIG. 2C, in this example the user has one existing project titled “Magic flywheel”.

Contributions and Deposits

After a user has registered, he or she can contribute to a project by submitting one or more contributions to the project. In the currently preferred embodiment, file(s) may be contributed to a project using a project user input interface provided by the present invention. In addition to uploading the file, the user is prompted to provide a description of the file and what amount of equity is claimed for his or her contribution. It should be noted that generally a user is only considered to be a “contributor” or “member” of a project after he or she has been accepted by the other contributors though the voting procedure described later in this document. Thus, although the terms user, contributor and member are sometimes used interchangeably in this document, not all users of the system may, in fact, become contributors to or members of a given project. For example, some users may only browse the system for information about projects of interest. A user can become active in a project by submitting a file or other contribution to the project. This contribution process typically involves uploading of a new file containing new material or submitting an updated version of an existing file.

A first aspect of the present invention is that it offers a solution that facilitates and manages the process of making contributions or submissions to project(s) of interest. When a user submits a contribution, the submission is not only stored, but is also deposited with a deposit authority in order to provide evidence (vis a vis third parties) of the deposit. Using a system constructed in accordance with the present invention, a user can upload data (e.g., a file containing images, code, documents or various other types of materials) to a server (e.g., web server). The solution can accept numerous different types of data in a wide variety of formats. The present invention generally permits users to upload almost any type of material in a file. FIG. 2D is a screenshot illustrating the submission screen 240 provided in the currently preferred embodiment of the present invention. As shown at 241 at FIG. 2D, the user may select a choose file button to select a file (e.g., README.txt) for submission to the “Magic flywheel” project. When the user has selected a file, he or she can hit the “Upload” button 242 to upload the file to the server as shown at FIG. 2D. In its presently preferred embodiment, the system also includes a feature (not separately shown at FIG. 2D) that enables a user to prepare and submit a basic drawing (e.g., line drawing or hand drawing) to accompany the submission. Alternatively, the system may display the preview image (which is generated as described later in this document) and allow the user to review the generated preview image and enter comments. As another alternative, a user can upload a drawing file as part of the contribution. Other images, code, documents and a variety of other materials can also be submitted. The user can also claim certain equity as a result of his or her contribution. If the user's contribution is accepted, the user is then considered a contributor to the project and may be rewarded for his contribution by receiving equity. Currently, the attribution of equity to a given contributor is validated by other contributors of the project, who vote for that purpose as described below.

When an uploaded data file is received, the system creates and associates certain metadata with the uploaded file (e.g., timestamp, contributor information, project to which it relates etc. as described below in more detail). Generally, the contents of the file are not examined as part of the submission process, however, a file signature (e.g., checksum) is generated to verify file integrity during handling, a timestamp is applied to verify the time of submission, and other data is recorded to associate the submitted contribution with a particular user, project and so forth as hereinafter described in more detail. For one thing, the system creates a local deposit identifier (ID) for the uploaded file. One reason for the local deposit ID is that the present invention provides for consolidation of multiple data files received from users into a single submission for filing with a deposit authority. The ability to consolidate multiple data files into a single submission enables the present invention to minimize the number of deposits with external deposit authorities that are required. In addition to the local deposit ID, an external deposit ID (e.g., identifier received from external deposit authority) is also associated with the uploaded data file after a deposit is made with an external deposit authority as hereinafter described.

Once the file has been accepted and added to the project it is sent to a deposit proxy (which can actually be implemented on the same server as the one hosting the project or a different machine). The deposit proxy, in turn, generates a unique, private deposit ID that is associated with the submitted file. The deposit proxy consolidates a plurality of private deposits (i.e., multiple contributions from different users) and makes a formal deposit with an external deposit authority at a certain frequency (for instance, once a day or once a week). In this manner, the present invention allows multiple deposits to be combined (consolidated) into a single submission with a deposit authority, thereby reducing costs (compared to each contributor making a separate deposit). However, the present invention also handles a single deposit of a single submission, if desired (e.g., for large, new submissions). When the deposit with the deposit authority is made, an external deposit ID is received for the consolidated deposit. This external deposit ID is kept by the proxy and associated by the system of the present invention with each of the private deposit IDs of the contributions (submitted files) that made up the deposit. Currently, the system does not provide access to this external deposit ID to users, but instead provides them with the private (local) deposit ID. However, as the external deposit ID is associated with each local private ID, the system can determine which deposit made with a given deposit authority contains a particular contribution (e.g., by look up of the external deposit ID associated with a given private deposit ID in the database).

In addition to facilitating the process of making a deposit, the present invention also provides several features enabling users to make such deposits or contributions to particular projects in a collaborative fashion. For one thing, particular contributions may be associated with particular projects (e.g., the Magic flywheel project as previously illustrated at FIG. 2D). This allows users to work more collaboratively and to create a community of contributors around a particular product, technology or other project. For example, the above-described project seeking to develop a more fuel efficient and environmentally sensitive “green” automobile could be organized to provide for users to make contributions to design of the green automobile or to particular components of the automobile. A user may, for instance, design an improved limited slip differential (LSD) to reduce the loss of drive which can result from spinning wheels on one side of an axle (e.g., from cornering or accelerating) and submit this design to the green automobile project.

After the contribution has been submitted it can be shared with others participating in the project. Depending on the type of project that is involved, the submitted contribution (e.g., limited slip differential design in this example) may be shared with a limited audience (e.g., in the case of a private project with a limited group of other contributors) or a broad audience (e.g., in the case of a public project made broadly available on the Internet for viewing/input). These users may review the submission and make comments or suggestions as to how it could be improved. For instance, two additional users may have further suggestions as to how the limited slip differential that was submitted by the original contributor may be improved. A first user may submit comments that are posted to the project. The original developer/contributor could then consider this feedback. Another user (e.g., automotive engineer) may submit a proposed improved design, which may include submission of computer-aided design (CAD) drawings and a written technical specification in a process similar to that described above with respect to the original contributor. The submission/contribution would go through the same upload and deposit process and be associated with the project. The original developer may then review it and, if he or she found it to be of value, use it as an improved design. The end result of the collaborative process on this and other components may be a complete plan for development of a green automobile that was developed based on the collective contributions of a large community of users. Those skilled in the art will appreciate that the foregoing are only illustrative examples and a wide variety of other contributions may be made to projects of various types, as desired.

Equity Sharing

Additionally, “equity sharing” features of the present invention may be utilized to provide a means for recognizing and/or rewarding contributors making contributions to a project and to manage the process of collaborative development by a plurality of users. It should be understood that the term “equity” used herein refers in general terms to recognition of the percentage contribution made by a particular user or organization. “Equity” does not necessarily represent ownership interest in any shares of stock or other financial instrument, although in some cases users of the solution may agree to allocate certain stock, monetary compensation, ownership interests or other consideration based on relative contribution of users to a collaboratively developed work. Instead, the term “equity” as used herein should be construed broadly to indicate recognition of the relative contribution given individual or organization has made to a collective work. Additionally, the award of equity in a project may give such individual or organization some vote or other input regarding development of the work, such as whether or not to accept other contributions that may be proposed (or made) by other users and/or the “equity” value to be awarded to such other contributors. It should be understood that the examples presented herein of equity sharing are made for purposes of illustration and not limitation. In the currently preferred embodiment, the equity awarded to a given user/contributor does not represent an absolute percentage of ownership of a project, but rather represents an amount of points based on the contribution(s) made by such user. The amount of total points in a project is not limited to any particular number of points. Thus, in the currently preferred embodiment of the present invention the total points allocated may increase over time as users make additional contributions to the project. The present invention is user configurable such that the manner in which equity is awarded may be modified for particular projects, products, sponsoring organizations or the like, as desired.

For purposes of illustrating, at a high level, the basic operations of the “equity sharing” features of the present invention, we will continue to use the example of contributions to a “Magic flywheel” project that are made using the system and methodology of the present invention. In this example case, assume the Magic flywheel project already exists and the user making the submission is already registered as a member of the project. Referring again to FIG. 2D, a user uploading a contribution can fill in an equity field 249 to claim equity relating to a submitted contribution. As shown at FIG. 2D, in the currently preferred embodiment the user may claim from up to 100 points of equity for a contribution. However, it should be understood that a different contribution range could be utilized, if desired. The user making a submission may also provide a justification for the equity claim. Additionally, other contributors voting on an equity claim may indicate that they believe an amount of equity different than that proposed by the user making the submission is appropriate. FIG. 2E is a screenshot of an equity vote screen 250 which provides that a contributor can indicate and different equity amount and includes a reason field 253 that enables the contributor to explain his or her rationale for proposing a different equity value. As described below in more detail, a contributor who votes ‘no’ on an equity claim may submit a different proposed equity value and use the equity vote screen 2E to provide an explanation of the rationale for the different equity value proposed. FIG. 2F is a screenshot of a confirmation screen 260 which provides confirmation of the uploaded file and the pending equity claim to the user.

In the presently preferred embodiment, the decision about whether or not to award equity to a given contributor is made by the user(s) already having equity in the given project. For example, if there is only one original contributor to a project, the original contributor having 100% of the equity initially determines whether or not to award equity to other contributors. If there are multiple contributors already having equity in the project, then in the currently preferred embodiment there is a vote amongst the contributors as to equity awarded to additional contributors. In the currently preferred embodiment, the vote of each contributor has an equal weight in determining whether to approve an equity claim and vote of a majority is required to approve an equity claim as hereinafter described in more detail. However, in an alternative embodiment the voting can be weighted with the weight of each contributor's vote equal to the portion of the equity the contributor owns. In such an alternative embodiment, the vote would need to cumulate at least half of the equity of the project for the equity claim to be approved. When a contributor/member that is voting declines an attribution of equity claimed by a user, he or she can submit an amount that is deemed more appropriate, if desired. If the represented majority of equity declines the decision, then the vote occurs again, using the average value of equity calculated from the previous vote. The values submitted by contributors who accepted the vote are kept for calculating the new value, and these contributors are not required to make additional votes. The above process can be illustrated by the following example:

### VOTING EXAMPLE

Equity claimed by contributor: 100 points.

10 existing contributors in the project, each one owning 100 points (total equity of 1000 points)

4 vote yes (100 points), and 6 vote no and submit 80 points as the value for this contribution.

Second round will be for rewarding the contributor of (4×100+6×80)/10=88 points.

2 positive votes will be needed for accepting the attribution of 88 points (4 positive votes of first round+2=6 out of 10).

Additionally, the organization operating the website/service may also retain a portion of the equity in each project. For example, the corporation, society, or other organization operating the server may receive a certain amount of equity for offering the contribution and deposit service, for instance 10 points for each deposit for each project. The organization operating the system may also be rewarded for managing the vote (e.g., 10 points for the first round and 5 points for each additional round). Thus, in the case described above total equity of 103 points may be awarded based on the contribution as follows: 88 (reward for user filing the contribution)+10 (first vote)+5 (second vote)=103 points have been added to the total equity of the project. 88 points are for the contributor and 15 for the society or organization that is running the system accepting the deposits and organizing the vote. FIG. 2G is a screenshot of an equity summary screen 270 showing the allocated equity for the example “Magic flywheel” project. As shown at FIG. 2G, several equity claims have been accepted and several other equity claims are pending resolution by the contributors. Those skilled in the art will appreciate that the foregoing examples are for purposes of illustration and not limitation as there are a number of implementation choices that can be made as to how equity may be allocated to contributors to a given project.

### System Components

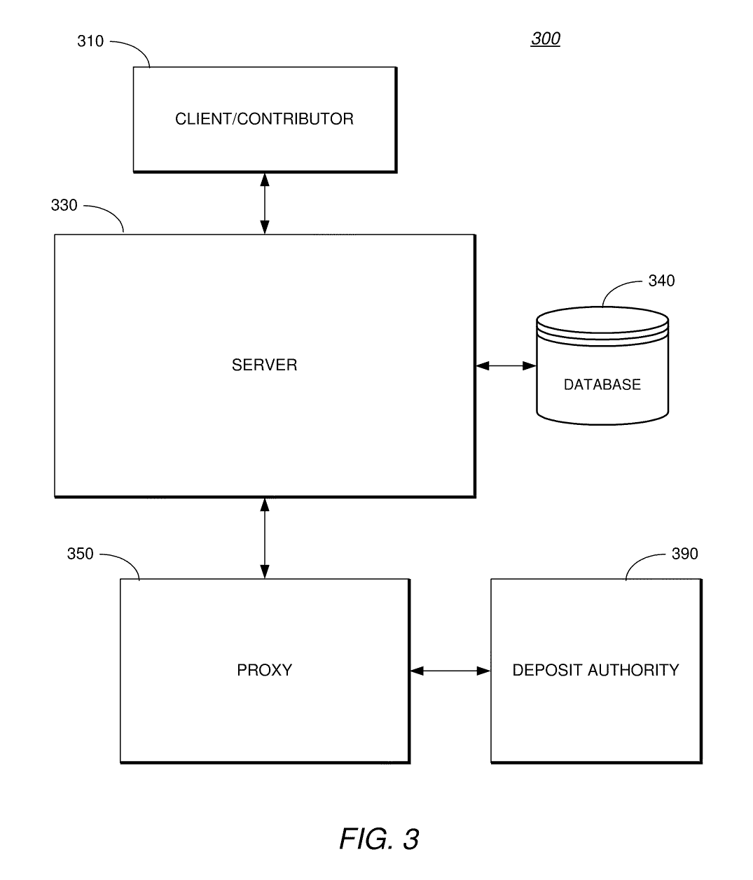

FIG. 3 is a block diagram illustrating an environment 300 in which the present invention may be implemented. As shown, environment 300 includes a client/contributor 310, a server 330, a database 340, a proxy 350 and a deposit authority 390. It should be noted that although the server 330 and proxy 350 are shown as separate components, the proxy 350 could be implemented as a component of the server 330 or as a separate module, as desired.

The client/contributor 310 is a client side component of the present invention, which may be utilized by users to, among other things, upload contributions and user input to server-side components of the present invention. In the currently preferred embodiment a client-side component is used to collect information and instructions from a user(s)/contributor(s) and facilitate the upload of contributions. The client 310 is connected to the server 330 via an available network (e.g., via the Internet). It should be noted that although a single client/contributor module is shown at FIG. 3, typically the system would have a plurality of client/contributor users, each of which interacts with the server using client-side components of the present invention.

The server 330 is a core component of the present invention and includes functionality for receiving uploads of submissions (contributions), recording data about the uploaded contributions, invoking the proxy to create a deposit for submission to a deposit authority and notifying the client/contributor when a deposit has been made. The server 330 creates and maintains records about contributions received and corresponding deposits made with a deposit authority based on these contributions. Additionally, the server 330 includes equity sharing functionality for allocating and adjusting equity of contributors to a given project. The server interacts with a database or repository 340 for storing information received, generated and used by the system. In the presently preferred embodiment the database is an SQL database, although another type of database or file system could be utilized if desired.

The proxy 350 is shown as a separate component at FIG. 3, but can be implemented either as part of the server or as a separate component as previously mentioned. The role of the proxy 350 is to interface with a particular deposit authority to aggregate contributions uploaded by multiple contributors into deposits and make these deposits with a deposit authority. In typical operation, the proxy aggregates multiple contributions over a period of time into a deposit. The period of time is user configurable and may, for example, be daily or weekly and/or may be based, at least in part, on volume of contributions to be deposited. As shown, the proxy 350 receives information from the server 330 and interacts with the deposit authority 390. The proxy then makes the deposit with the deposit authority and receives in return an identifier or key from the deposit authority. After the deposit is made, the proxy returns this external deposit identifier (ID) to the server as evidence the deposit has been completed. Note, that in some cases particular deposits may be made physically (e.g., submitted on a CD or DVD or other media) and in such case a copy of the deposit is also returned. However, it is currently anticipated that in many cases deposits will be made electronically.

The deposit authority 390 represents a third party deposit authority that accepts and maintains records of deposits. An example of a deposit authority is the previously-discussed Interdeposit deposit authority. Although a single proxy 350 and deposit authority 390 are shown at FIG. 3 for convenience, in operation the server 330 may interact with a plurality of deposit authorities through one or more proxies. Thus, a system constructed in accordance with the present invention may include multiple proxies that are implemented to interact with a plurality of deposit authorities (e.g., deposit authorities in different countries). Alternatively, the system may include a single proxy that supports interaction with multiple deposit authorities.

### Detailed Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

Contribution Workflow

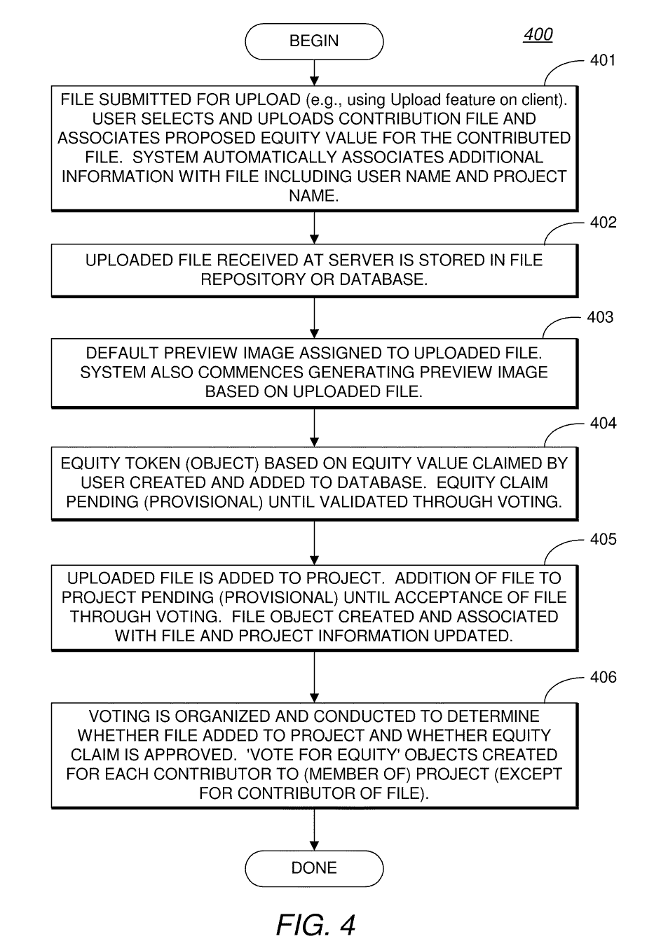

FIG. 4 comprises a high-level contribution flowchart 400 illustrating contribution features of the present invention. Assume that a user of the system who has previously registered and is a member of a project has prepared a file that he or she wants to deposit as a contribution to this project using the present invention. The file may be an image, source code, video, text, audio file or of any kind of digital data. The process commences at step 401 with the user submitting a contribution file for upload. Using a client side component (e.g., an Upload feature provided on the client 310 as shown at FIG. 3), the user may select and upload a contribution file and may also associate it with a value of equity that the user considers he or she deserves for this contribution. Currently, the value of equity is an integer between 1 and 100 but another range of values could be used, if desired. In the currently preferred embodiment, a feature is provided to enable this submission of a contribution to be performed by filling in an HTML form and hitting a ‘submit’ button as illustrated, for example, at 241, 242 and 249 at FIG. 2D. When the Upload feature is invoked the client-side component also associates other relevant information with the submitted file, including but not limited to the user name, project to which the file is submitted, and the amount of equity claimed by the user as a contributor of the project to which the file is submitted.

When an upload is received at the server, at step 402 the uploaded file is stored in a file repository or database (e.g., database 340 as shown at FIG. 3). More particularly, an upload( ) function is invoked at the server 330, which causes the uploaded file to be stored in a file repository or database. In the currently preferred embodiment, the repository is implemented as a SQL database and file is physically stored on the persistent storage system of the server. However, the file repository can alternatively be implemented as a reference to an external storage solution, with the current implementation of the system making it possible, for example, to store files on an external server available from a web or “cloud computing” service such as Amazon Simple Storage Service from Amazon.com or Acrobat.com from Adobe Systems, Inc. Various other types of databases or file systems could be used for storing the deposits, as desired.

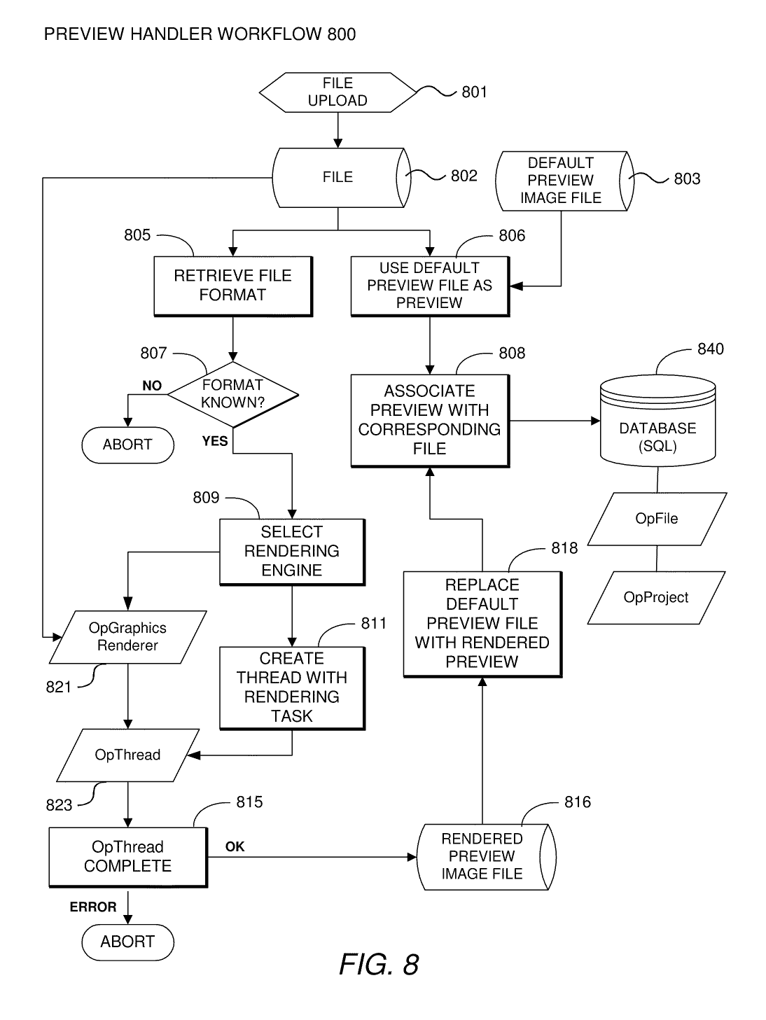

At step 403 the system assigns a default preview image to the uploaded file that can be used as a thumbnail or icon when the file is listed or should be represented visually (e.g., displayed in graphical user interface to a user of the system). The system also commences generating a preview image based on the file as described in more detail below and illustrated at FIG. 8.

Next, the system creates an equity token (object) in the language of the server application (currently Python, however the server application could be written using other programming languages if desired) and adds the equity token to the database at step 404. In the currently preferred embodiment, an object (OpEquityItem) is created to represent the amount of equity the user requests for uploading the file. The equity object (OpEquityItem) also contains information such as the file (contribution) for which the equity is claimed, the user it is associated with, and the status of the equity, which is pending at this step, meaning that the attribution (approval) of the amount of equity claimed by this user for this contribution (uploaded file) submitted to the current project has not been validated (voted on) yet by the other contributors of the project. At step 405, the uploaded file is added to the project. It should be understood that addition of the file to the project at step 405 is typically pending (provisional) at this stage until the voting process has been completed. In the currently preferred embodiment, acceptance of a contribution (as well as an associated equity claim) is pending until the voting as to whether to accept the contribution and the associated equity claim has been organized and resolved. This may involve one or more rounds of voting among contributors, as previously described. A file object (OpFile) is also created and associated with the submitted file. This file object contains data such as a reference to the file physically stored in the database and other information such as the user who uploaded the file and the project into which the file is being added. Additionally, the object representing the project (OpProject in the current implementation) is updated in the database with the information of the equity object added to the project.

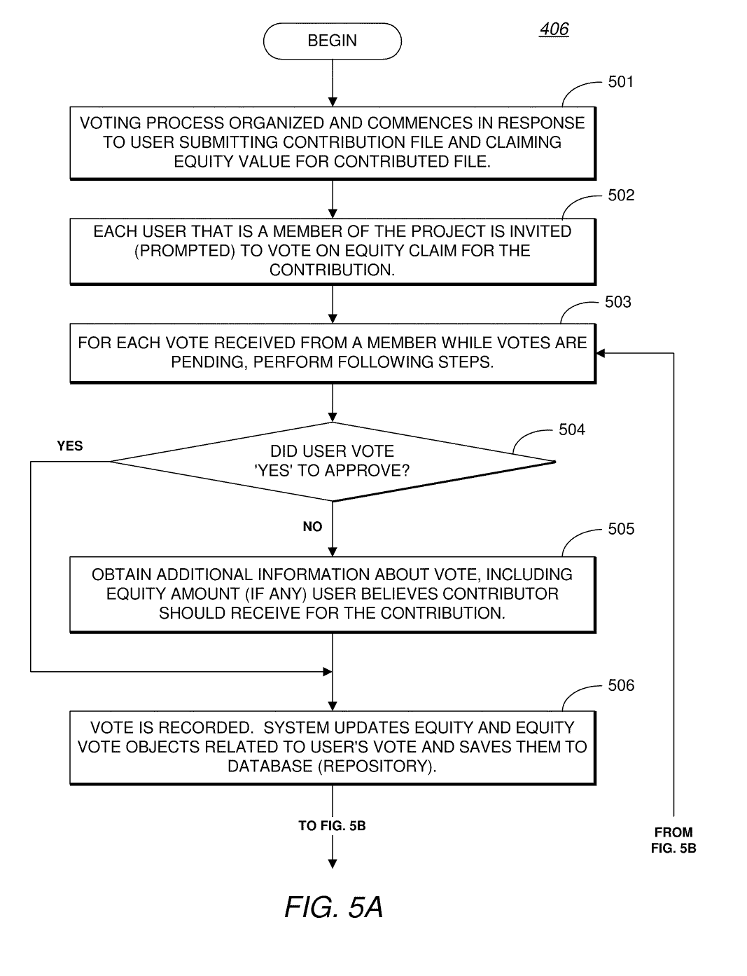

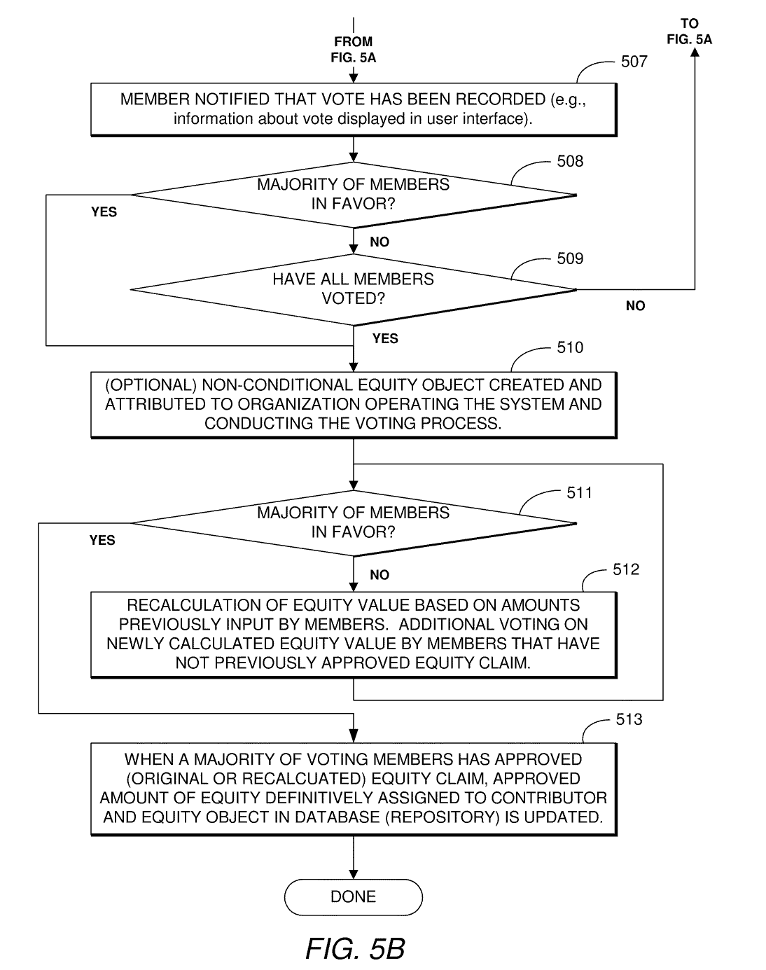

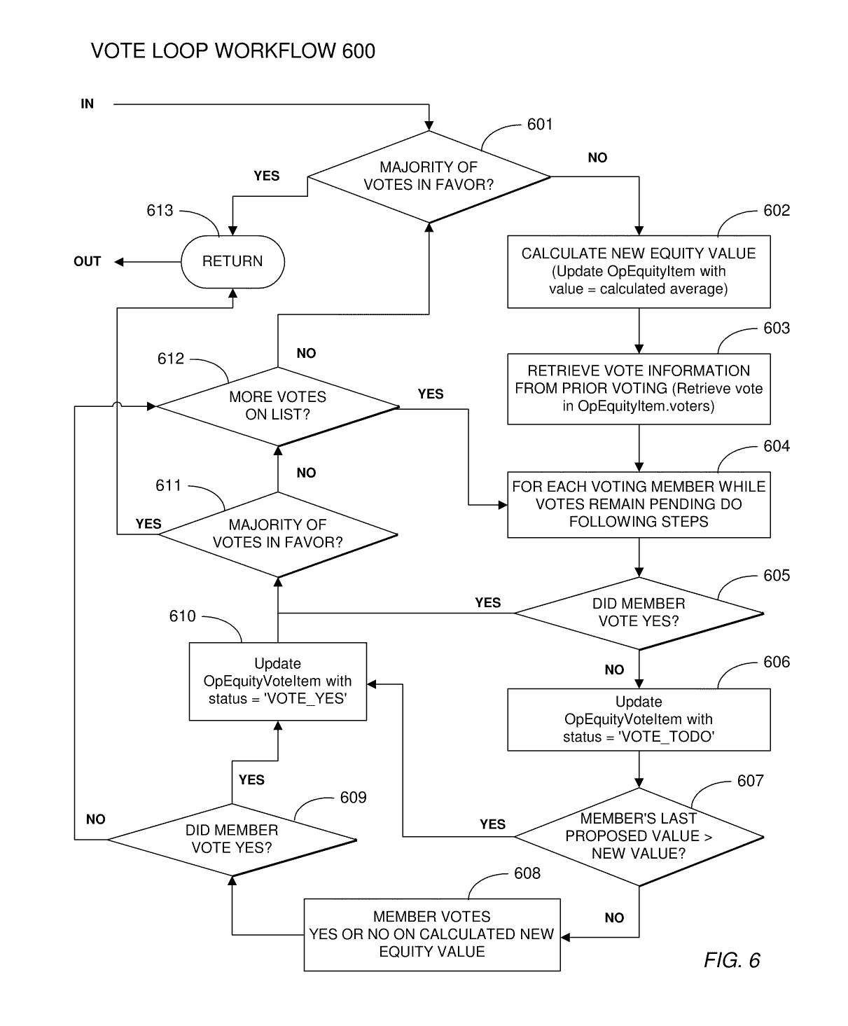

The system then organizes and conducts a vote as provided at step 406 to determine whether or not the existing contributors (members) of the project agree to add the file to the project and whether they approve the equity claim the user has requested for his or her contribution. This vote process includes creating a list of ‘vote for equity’ objects (called OpEquityVote objects or items in the currently preferred implementation). These objects contain information such as the equity object it refers to, the project, the file, user and the status of the vote. The system creates as many ‘vote for equity’ objects as there are contributors in the project, minus one; each object being assigned to each contributor of the project, except the one who is the owner of the equity being the subject of the vote. The ‘vote for equity’ objects are stored in the database. The currently preferred scheme is to store these objects in a separated table being referenced by the equity object being the subject of the vote, for performance reasons. However, the data could alternatively be associated with any objects related to the vote in any table maintained in the database, as desired. The voting process is described in more detail below and illustrated at FIGS. 5A-B and FIG. 6.

Vote Workflow

FIGS. 5A-B comprise a single high-level vote flowchart diagram 406 illustrating the voting process 406 of FIG. 4 in further detail. As provided at step 501 at FIG. 5A, the voting process is organized and commences in response to a user submitting a contribution file and claiming an equity value for the contribution. Once the vote has been organized, contributors to (members of) the project may vote on whether or not to accept the contribution and the amount of equity claimed by the user making a contribution. A contributor to a project that has his or her voting rights currently active is able to vote using the system of the present invention when contributions to the project are made as described above.

Members of the project for which an equity claim has been made are invited (prompted) to vote at step 502. Currently, each user that is a member of the project is advised of the equity claim and is invited to vote as to whether or not to agree to award the claimed equity. In the presently preferred embodiment members are informed by email that there is a pending equity claim on which they are requested to vote. Additionally, when members login to the project page they are prompted to vote if there is a vote on a contribution pending (e.g., by a link indicating that action is required on a contribution that has been submitted). In the currently preferred embodiment, a user interface implemented on the client side of the system allows user(s) to state his or her choice (the currently preferred scheme allows users to answer ‘yes’ or ‘no’ however it could offer any other possible answers such as ‘undecided’). In the case a user declines the equity claim (i.e., votes ‘no’ as to the amount claimed), the user is asked to provide an alternative amount of equity (if any) that he or she believes that the contributor who submitted the file should receive for the contribution. This action in the current implementation of the system is performed by clicking on one of several links titled ‘yes’ and ‘no’ but it could use any other way to let the user make a choice, including sending an electronic mail to a specific address, placing a phone call and so on and so forth. The voting process in the currently preferred embodiment will now be described in more detail.

In response to each user's submission of a vote, server-side components of the system receive information related to user's vote from client-side input module(s) while votes are pending as provided at step 503. In the currently preferred embodiment, the following steps 504-508 are performed for each vote that is received. At decision step 504, the vote is evaluated. If the user has voted positively (i.e., ‘yes’), the process proceeds directly to step 506. Otherwise, if the vote was negative (i.e., ‘no’), the process proceeds first to step 505.

In the case the user voted ‘no’ (i.e., vote received from this member was negative), the system interacts once more with the client-side of the system as provided at step 505 in order to obtain some additional information about the vote, including but not limited to the amount of equity the user believes the contributor who submitted the contribution which is subject of the vote should receive. If the user has not already submitted the information, the user may be prompted to provide this additional information by display of an appropriate user interface on the client side in which the user may respond by submitting the additional information requested (e.g., by filling some fields and hitting a ‘submit’ button in the current implementation). The system then proceeds to step 506 to update the vote object in the database (repository) as provided below.

Once the user has voted and provided any additional information (if any) requested by the system, the vote is recorded at step 506. More particularly, in the currently preferred embodiment the equity and ‘equity-vote’ objects related to the user's vote are updated and saved to the database (e.g., by updating the OpEquityVoteItem object). The system then notifies the user (member) that his or her vote has been taken into consideration, by displaying some appropriate information to the member (i.e., at the client-side component) at step 507. Although this notification step is not necessarily required to tabulate votes of the members it is provided in order to inform members that their vote has been received. Next, as provided at decision step 508 a check is made to determine whether a majority of the members has voted in favor. For example, if there are 10 existing contributors in a project with each contributor owning 100 points (total equity of 1000 points), the affirmative vote of six of these contributors is required. If a majority is in favor, then the method proceeds to step 510. This is an optimization to end the voting process early once a majority has voted in favor of the equity claim. Otherwise, if a majority has not been obtained, the process proceeds to decision step 509 to evaluate whether the vote submitted by this user was the last one in the list of votes pending for the attribution (validation) of this equity claim. If all members have voted, the process proceeds to step 510. Otherwise, the method returns to step 503 as shown at FIG. 5A while votes remain pending.

If the system determines that the current vote was the last vote for the related equity (i.e., all members have voted on this equity claim) at decision step 509 or if a majority of contributors has voted in favor of the equity award at step 508, then in the currently preferred embodiment a non-conditional equity object is created at (optional) step 510 which is attributed to the society or organization operating the system and organizing the voting process. The amount of equity is predefined and automatically validated. In the currently preferred implementation of the system, the amount of equity attributed to the society or organization operating the solution is 4 points for the first round of voting and 2 points for each additional round of voting. However, a different value could be used, if desired or the society or organization could receive equity or compensation in some other fashion (i.e., this step could be omitted).

Next, at decision step 511 the system checks to determine if a sufficient majority has voted in favor of the current equity claim being considered in order to allow the equity to be granted. If a majority vote has been obtained, the process proceeds directly to step 513. However, if a majority vote in favor of granting the claimed equity for the contribution is not found at decision step 511, then at step 512 the system retrieves information regarding all of the users (members) who voted against the claim (i.e., voted ‘no’) from the database, and re-organizes a vote for those users, using a new proposed equity value. In the currently preferred embodiment of the present invention, the new amount of equity is the average of values of equity submitted by users who voted no, and values of originally submitted equity for users who voted yes. (It should be noted that in an alternative embodiment, the system could use various other kinds of calculations to suggest an alternative equity amount, including, for example, calculations that are based on the weight of each user into the related project corresponding to the equity such user owns in the project). After the new equity amount is calculated in the currently preferred embodiment of the present invention, the system automatically enters affirmative votes (i.e., ‘yes’ votes with positive status) for all users that have previously submitted a value of equity superior or equal to the new calculated equity value as described below and illustrated at FIG. 6. The other members that did not submit a value equal or superior to the new value are asked to vote on the new value. This portion of the voting process involving those members of the project that did not approve (i.e., vote in favor of) the equity amount previously proposed and voted upon is illustrated in FIG. 6 and is described in more detail below. After votes on the newly calculated equity value are received, the process returns to decision step 511 to determine if a majority of the votes of all members are in favor of the new equity. If, including those votes from the additional voting at step 512, the majority is met then the process proceeds to step 513. If not, then the process may continue until a majority have approved an equity value in the manner described below in more detail. When a majority of the members voting has approved an equity claim, the approved amount of equity is definitely assigned to the contributor and the equity object is updated with the approved amount at step 513. It should be noted the equity value approved could be the initial amount that the contributor originally requested for the contribution or it could be a reduced amount calculated based on input from other members and approved as described above. The process concludes with the definitive approval (validation) of an equity claim.

Vote Loop Workflow

FIG. 6 comprises a high level vote loop workflow diagram 600 illustrating the voting loop (additional voting) process of steps 511-512 of FIG. 5B in further detail. As previously described, a user who previously registered as a user of the system and became a contributor to (member of) a given project is invited to vote when another user submits a contribution to the given project (e.g., the example “Magic flywheel” project previously described) and claims an amount of equity based on the contribution. In its currently preferred embodiment, the present invention manages the initial voting process on the server side system as described above and illustrated in flowchart diagram 406 at FIGS. 5A-B. In cases where a majority of the members of a given project do not approve the amount of equity originally claimed by a contributor, an additional voting process may be required. The organization and operation of this additional voting process is briefly described below and illustrated in the vote loop workflow diagram 600 at FIG. 6.

As described previously, if a majority of the voting members have approved an equity claim as shown at decision step 601, the method simply returns as provided at 612 and the equity is validated as previously described and illustrated at FIG. 5B. However, if a majority of the members did not vote in favor of an equity claim, the voting process is reorganized and the following additional voting procedures are performed. At step 602 the system calculates a new value for the equity claimed by the user submitting the contribution as previously described. In the currently preferred implementation, the new value is the average of the values previously input by each of the voting members. This average is simply calculated by dividing the sum of all submitted values of equity by the number of contributors. In other words, the current implementation doesn't consider the weight of each contributor (member) within a project; however, in an alternative embodiment the votes are weighted based on the relative equity amount held be each contributor who is voting in determining the revised equity value to be considered.

At step 603, the system next retrieves the Vote objects found in the list of Equity objects. In the currently preferred embodiment of the present invention, this is performed by running an SQL request against the database that provides a list of such objects; however any kind of database or file system could be used, as desired. Commencing at step 604, the following routine is then performed for each vote item found in the list of Vote objects.

At decision step 605, the system examines the vote of each user (member)in the prior round of voting and takes action depending on the result of the vote -the current possible values are ‘YES’ or ‘NO’ but the implementation could consider other options such as ‘BLANK’ or ‘UNDECIDED’. If the result is ‘YES’ the vote status remains as ‘VOTED_YES’ and the process proceeds directly to step 611 as shown at FIG. 6. However, if the result is ‘NO’, then the system updates the status of the vote object being currently managed in the loop, by setting its status to pending (currently implemented as ‘VOTE_TODO’) as provided at step 606 at FIG. 6. At decision step 607, the value previously submitted by user when he voted ‘NO’ is compared to the calculated value (i.e., the revised equity value described above which is now being considered). If the value previously submitted by the user is equal to or greater than the calculated value, then it is considered that the user accepts the average value, the process proceeds to step 610 and this vote is marked ‘VOTED_YES’ as shown at step 610. Otherwise, if the value previously submitted is less than the calculated amount, the vote remains pending and the system proceeds on to step 608 as shown at FIG. 6.

At step 608, the member is requested to vote on the newly calculated equity value that is proposed. The member's vote is evaluated at decision step 609. If it is determined that the member voted yes, then the status of the vote object is updated as provided at step 610. A check is then made at step 611 to determine if a majority of the members are in favor of the current equity value being considered. If a majority are in favor, then there is no need for further voting and the process returns as provided at step 613. Otherwise, if the member voted no at decision step 609, the method proceeds directly to step 612. At step 612 a check is made to determine if more unprocessed votes are available in the list. If yes, then the system runs the routine again as shown at 604 through 611 while votes are pending. Otherwise, when it is found at step 612 that all member votes have been processed, the routine proceeds back to step 601 as shown at FIG. 6 to evaluate whether a majority of the votes are in favor of the calculated equity value for the contribution. If a majority of the members have voted in favor, the method returns as provided at step 613 at FIG. 6. At this point if a majority of members are in favor, the newly calculated equity value is approved and this amount is validated as provided at step 513 at FIG. 5B. Otherwise, the method may be repeated if a majority of the voting members have not approved the equity claim.

Deposit Workflow

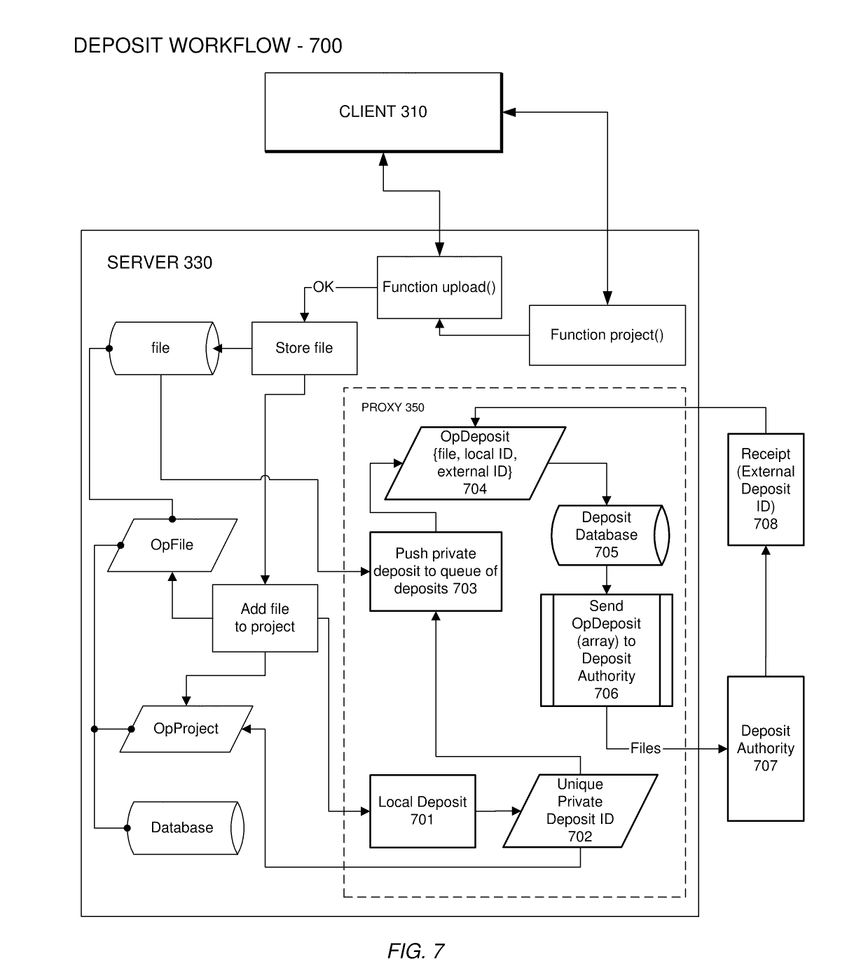

As described previously and illustrated at FIG. 4 after a contributor has uploaded a file to the server-side components of the present invention, the system has stored the file and created database objects. FIG. 7 is a high-level deposit workflow diagram 700 illustrating the process of making a deposit of the file (typically aggregated with other submitted files) with a deposit authority in further detail.

As shown at 701 at FIG. 7, the file uploaded by a user is submitted to a local deposit function which identifies the file by assigning it a unique identifier (Unique Private Deposit ID as illustrated at 702 at FIG. 7) using its checksum. The checksum is generated by one or more cryptographic hash function(s). The current implementation uses a Secure Hash Algorithm function and, more particularly, the SHA-224 algorithm, a variant of the SHA-2 Secure Hash Algorithm. However another secure hash algorithm or message digest function such as MD-5 could alternatively be used, as desired. Next, the hash or unique “private deposit ID” is pushed back to a queue of local deposits 703 which are to be submitted to an external deposit authority. In the currently preferred embodiment of the present invention this queue is managed by a dedicated SQL database as illustrated at 705 at FIG. 7 (i.e., a separate database than the one used for managing data of the rest of the application). However, any database or file repository, including the one already in use for other operations performed by the system could be used if desired. As shown at 704 at FIG. 7, the system next updates the deposit database 705 with a Deposit object (OpDeposit), which contains information about the deposit such as, but not limited to, the file and the local or private deposit id, and an empty field ready to receive an external deposit id (e.g., from the deposit authority).

As provided at 706 at FIG. 7, the system retrieves an array of deposit objects from the deposit database 705 and sends them to an external deposit authority as shown at 707. In the currently preferred embodiment, these operations are performed by server-side components of the application independently of other operations performed by the solution at a frequency that is user configurable. In the currently preferred embodiment, the system sends data deposits data electronically to the IDDN/Interdeposit agency every 24 hours; however any media and any method could be used to send the data to any available deposit authority at the same or a different frequency as desired. When the authority returns a receipt for the deposit as shown at 708, the global unique identifier (external deposit id) contained in the receipt is associated with the related deposit object (opDeposit) 704 and stored in the deposit database 705 as shown at FIG. 7. In this manner each of the local deposits (with a given local deposit id) is associated with the external deposit id received from the deposit authority. In other words, the external identifier received from the deposit authority is associated with each of the contributions that were included in the deposit.

Preview Image Generation

FIG. 8 is a preview handler workflow diagram 800 depicting the methodology of the present invention for generating a preview image of an uploaded file. In response to the uploading of a file as illustrated at 801 at FIG. 8, the uploaded file is received at the server at 802. As mentioned previously and illustrated at 403 at FIG. 4, when a file is uploaded to the system, the uploaded file is initially assigned a default preview image that can be used as a thumbnail or icon to represent uploaded file. As shown at 806 at FIG. 8, a default preview image file 803 is initially used to represent the uploaded file and is associated with the file as provided at 808. The currently preferred embodiment of the present invention uses a transparent 2 by 2 pixel image in the PNG format as a default preview image of a file, but alternatively any file format that is supported by common web browsers could be utilized as desired. Also, the present invention is configurable so that the content and definition of the image file can be specified differently according to different requirements, for instance a default icon of image could be used as the default preview for any file uploaded on the server. This file is currently shared unique and shared as preview for all files for which an actual preview image has not yet been generated; however it could be duplicated or shared in various fashions if desired. For instance, the default preview image that is displayed could be specific to one or more of the uploaded file's attributes such as file type, size, security scheme, or the like.

At the time the default preview image is assigned, the system also retrieves the file format of the uploaded file as provided at 805 at FIG. 8 and checks at 807 if it is a format for which the system can generate a preview image. If the format is unknown or an error occurred then the operation of generating a preview image for the uploaded file is aborted, and the default preview image will remain as the preview for the uploaded file. If the file is of a known format then the system selects an adequate graphics renderer (rendering engine) as provided at 809, creates an instance of this renderer (e.g., an ‘opGraphicsRenderer’ object 821 as shown at FIG. 8) and assigns this instance to the uploaded file and to a new thread (e.g., an ‘opThread’ object 823 as illustrated at FIG. 8). The currently preferred embodiment of the present invention utilizes a separate thread to render the preview of the file in order to provide users a better experience (e.g., with no delay in performing other operations while the preview is being rendered). With the use of a separate thread, the system responds immediately after the file has been uploaded, enabling a user to perform different tasks using the system while the preview for the uploaded file is generated and associated with the uploaded file in the database. For example, to render and save a PDF file containing several hundred pages into a format that any web browser can render such as JPEG or PNG may take several minutes. However, it should be noted that the use of a separate thread is a performance optimization and not a requirement. Those skilled in the art will appreciate that the system could generate the preview sequentially or asynchronously, or it could even use a separate process for that task.

The currently preferred embodiment of the present invention also makes it possible to use a renderer (‘opGraphicsRenderer’) that is created and runs on another system. For instance, in the case when the system is requested to preview files specific to the Macintosh OS X operating system, the renderer can run on a Macintosh computer system (e.g., Macintosh server), while other components of the system run on a Linux (or Windows) server. If from the system's point of view this is still a thread of the ‘opThread’ type, this is technically a separate process which can run on a separate computer if desired.

When the process of creating a preview image for the file has been successfully completed as illustrated at 815 at FIG. 8, the rendered preview image 816 replaces the default preview file as provided at 818 and is associated as preview of the uploaded file in the database 840 as provided at 808. However, if an error occurs during the rendering of the preview image at 815 then the operation is aborted and the default preview image will remain as preview for the uploaded file.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A computer-implemented system for management of collaboration among a plurality of users, the system comprising:
a computer having at least a processor and memory;
an input module for receiving input of a file submitted by a user to a designated project hosted by the system and input from the user and contributors associated with the designated project regarding the submitted contribution, wherein said input includes input regarding an equity value associated with the submitted file;
a storage module for storing the submitted file and data relating to the submitted file; and
a server module for depositing the submitted file with an external deposit authority, soliciting input from the user and contributors associated with the designated project about the submitted file, calculating an equity value for the submitted file based on input from the user and said contributors and maintaining the calculated equity values with other equity values calculated for contributors to the designated project.

2. The method of claim 1, further comprising:
a computer-readable medium having processor-executable instructions for performing the method of claim 1.
